(19) United States
(12) Patent Application Publication
(10) Pub. No.: US 2006/0090073 A1
(43) Pub. Date: Apr. 27, 2006

(54) System and method of using human friendly representations of mathematical values and activity analysis to confirm authenticity

(76) Inventors: Shira Steinberg, Teaneck, NJ (US); Joseph Steinberg, Teaneck, NJ (US)

Correspondence Address: KLAUBER & JACKSON, 411 HACKENSACK AVENUE, HACKENSACK, NJ, 07601, US

(21) Appl. No.: 11/258,593

(22) Filed: Oct. 25, 2005

Related U.S. Application Data
(63) Continuation-in-part of application No. 11/114,945, filed on Apr. 26, 2005.
(60) Provisional application No. 60/565,744, filed on Apr. 27, 2004.

(51) Int. Cl. H04L 9/00

(52) U.S. Cl. 713/170

(57) ABSTRACT

A system and method for representing mathematical values in a human friendly way, identity authentication that comprises the use of a function (including a one-way mathematical (hash) value) for verification of activity and/or transaction veracity and/or the identity of a computer system, user-friendly graphical/audible verification representations of the same, and log/transaction/activity monitoring that acts as a redundant check to avoid the subsequent execution of transactions that may have been fraudulently issued and to improve the security of the representation system.

### RELATED APPLICATIONS

The present application claims priority under 35 U.S.C. §120 from U.S. non-provisional patent filing Ser. No. 11/114,945 filed Apr. 26, 2005, which claims priority from provisional Patent Application Ser. No. 60/565,744 filed on Apr. 27, 2004, the entire disclosures of which are hereby incorporated herein by reference.

### BACKGROUND OF THE INVENTION

Various approaches have been proposed for combating different types of online identity-related fraud such as phishing. As commonly understood, phishing is the activity of fraudulently presenting oneself online as a legitimate enterprise in order to trick consumers into giving up personal financial information that will be used for either identity theft or other criminal activity. Phishing is most commonly perpetrated through the mass distribution of e-mail messages directing users to a web site (such as spurious “warnings” directing users to “log-in” to a given web site, etc.), but other venues are utilized as well. In recent months, phishing has been further refined with response to pharming techniques, a type of phishing in which mischievous parties cause users to be incorrectly routed to a imposter site rather than a legitimate site—even though the user entered the correct name of the site in his or her browser. There are other forms of phishing as well. As used herein, pharming and all other forms of online and electronic fraud which involve impersonation (as well as non-computer fraud involving impersonation in a fashion similar to the computer-related fraud discussed herein), are included in the term “phishing.” As those skilled in the art will recognize, phishing and other related online fraud is of widespread, growing concern, and has attracted the attention of the Federal Trade Commission and other government bodies, and has attracted increased major media attention.

Known approaches to stopping online identity-related fraud like phishing, tend to be overly simple in their approach to defeating what is a complex problem. In actuality, known approaches have no comprehensive solution continuum that avoids the typical weaknesses of human users (e.g., gullibility, ignorance, etc.), or the usual weaknesses of “one-shot” technological approaches. By way of some illustration, current methods of combating phishing may include crude “solutions” such as: the issuance of instructions to humans not to fall prey to phishing scams; the maintaining on users' machines of a black-list of known phishing sites; the maintaining of a list of valid sites on users' machines; sending users secret passwords; utilization of so-called “email security systems” (e.g., that attempt to filter out phishing-related emails); requiring the use of site-specific cookies; etc. As those skilled in the art will readily appreciate, each of the above and others that may be found in the prior art are technologically and/or realistically deficient, and are failing to stem the occurrence of phishing and other related fraud. Others serious infringe on user experience enough to frustrate many users into simply abandoning usage of the system altogether.

### SUMMARY OF THE INVENTION

To this end, the present invention (and that described in the earlier filings mentioned at the start of this filing) is directed to a system and method provide a user friendly representation of a function that are easy for people to recognize and retain in their memory, and may be used in many different applications for providing authenticity in an electronic system, including uses such as preventing online fraud etc., through which it may offer at least the following advantages in that it: makes it nearly impossible for phishers to produce a user experience that accurately mimics the experience of a real site (for example, producing a login page that looks like a legitimate login page belonging to a specific organization, to send an email that looks like a legitimate email from a legitimate organization, to creating an ATM experience that looks like a real ATM experience, etc.); does not rely on unrealistic human vigilance; and does not require site-specific software, emails, or lists that are often outdated, that may present technical issues for users running various other software, or considered a nuisance by users. The inventive solution provides the above by providing modules and means that offer a human friendly representation of encrypted or one way function mathematical values (or any other mathematical calculations) that may be displayed on any user terminal (whether computer handheld, ATM, etc.) and will enable and by enabling a given online computer system of a transaction entity (meaning any computer system that in any way interacts with humans or other computer systems) to progressively “build” a displayed image based on the user's credentials or other information as he types (or has previously typed, or as is otherwise known), but avoids the security concerns and maintenance issues inherent in server-based storage of passwords, etc. Alternatively, it may use audible sound representations or a combination of audio and visual cues. It may also use a database in lieu of, or in conjunction with, the mathematical calculations. In all cases the human-friendly representation may be built progressively, may involve multiple distinct representations, or may use a single representation. Under the present invention any given server utilizing the system and method described herein does not store or reveal any passwords (for authenticating the system to a user), and does not require that the user receive any secret information in the traditional sense. According to the present invention, the user can easily recognize if the displayed image or audible sequence or both is correct, and only he knows if the image being built or sounds being sounded (including potentially the reading of words) is the correct one because a one-way (cryptographic) hash (or other one-way mathematical function) is performed on some identifying material (the user's ID and password or other text inputted by the user in a web instantiation of the product, the user's email address or any other user-related information in an email instantiation, a user's ATM card number in an ATM version, other items, etc.) and an easily recognizable or easily remembered color/shape/image/letter/number/other visual cue is displayed on the user's terminal and/or a sound sequence is heard. It is also possible that instead of user identification information an SSL certificate or information about a user or about the server may also be included (or included instead of earlier said identity information) as data against which the mathematical function is applied in order to generate representations. In the case of an SSL Certificate or other pre-existing authentication-related element, the calculations et. al. may be performed on it or its components to generate a human-friendly representation of the item—so that users can more easily recognize if a certificate or other authentication item is correct. In one example, they may see the same representation every time they login to a specific secure site—because the same certificate is used—if the certificate were changed or an incorrect site accessed the representation that users would see would change. (The invention could be implemented as client-side, could work in a fashion that checks that the certificate is valid before displaying a representation, could add user information to the calculation in addition to information from the SSL certificate, etc.) More advantageously, the invention may be utilized in an open platform, and in the case of an open platform, the solution allows an organization to implement the specific embodiments discussed herein according to its own standards, and the exemplary illustration provided herein provides for plug-and-plug installation for most scenarios. To this end, the present invention may also be utilized in numerous applications ranging from financial related applications, to CRM applications as well as to legal, medical, and other applications, web-based, email-based, or any other form of computer interaction with humans and/or other computer systems. Furthermore, the invention may be implemented at both front end (e.g._making obvious to users or other computers before they login at the login page of a web site whether the site is real by presenting a visual cue (and letting them know that the sender of an email message is who it claims to be, that an ATM is legitimately on the ATM network and talking to the real bank, etc.)—or even after users login, by presenting such a cue, in emails presenting a cue, on ATM machines, etc.), and back (e.g checking for anomalous patterns of user activity either before or after users submit their logion credentials (or both)). The combination of front and back end protection is a unique invention as described above. The front-end and back-end can also affect each others' function—for example, if the system sees that numerous attempts to calculate and generate representations are run from the same machine with different usernames it may be configured not to display any more representations until some event (time threshold passes, administrator reviews records, etc.) transpires. As described herein, the invention may include the concept of giving significance to information obtained from a user's computer before he or she actually submitted their login information to the system; but in another illustrative embodiment, the present invention contemplates how such applications can be used.

In sum, the present invention relates to the confirming of authenticity in an electronic system, one exemplary implementation of which might be an on-line identity authentication system that comprises the (optionally progressive) use of a hash or other one-way (or other mathematical) function for verification, user friendly graphical, visual, and/or audio representations of the same, and log/transaction/activity monitoring and analysis that avoids the subsequent fraudulent execution and settlement of transactions or other activities, despite use of the representation-based protections described above (or if they were not utilized). In doing so, the invention offers a continuum of protection that comprises at least three components: (1) a unique approach to utilizing and representing a mathematical value or result of a mathematical function including a one-way mathematical function value (such as the exemplary “hash” or “one-way hash” as referenced herein) through the use of module and means for providing a simple to understand representation (e.g., sounds, the reading of words, words displayed, colored symbols like shapes/letters/numbers on a background, numbers by thousands, changing the background and/or text color on the display, or other visual cues), the user-friendly aspects of which extend beyond applications pertaining to on-line verification for preventing phishing; (2) a means and modules for a unique, (optionally) progressive “building out” of the aforementioned human friendly representation of a hash value on a user's screen (and/or speakers) as the user's key strokes are being entered (or after the keystrokes are entered or at another time; and (3) the unique component of practicing of subsequent intelligent log, activity, or transaction monitoring through a monitoring module and means for monitoring that adds a second level of protection against phishing and related types of fraud, such that, even if users are somehow successfully phished (or unauthorized parties otherwise obtain user login information) the phisher's activities may be caught by analysis of the logs/transactions/activities, so that fraud prevention may be maximized even after a user or users have successfully logged in to effectuate a transaction. (4) The unique ability to carry out through the use of a user related values gathering means for logging activities on users' computers before users complete a login process (or even click “submit”). Information garnered in this manner can be analyzed for suspicious patterns of activity as described in (3) above. (Present systems typically catch, log, and analyze activities after user's submit credentials—the invention includes doing so even before credentials are received by a back-end system and before the user has instructed his browser to submit credentials. Included in this are not only the logs of the actual application, but also aspects of the cuing system implementing the invention as well (as they may be analyzed to look for suspicious activity patterns—e.g., seeing multiple hashes of distinct usernames from the same computer or from computers in a region in which the user is not normally located, etc).

In one exemplary embodiment, the invention could be implemented in a manner such that it is delivered directly by an organization wishing to protect its users, or where other users or online providers may wish to utilize a third-party for transaction or activity veracity and/or identity verification. The latter case could be implemented in many different ways, but in one implementation, users would go to a web site, and in order to verify the authenticity of the site would submit their usernames (or any other piece of text) which would be sent to the third party along with information from the site being accessed, the third party would generate the cue, and reply. An email use of the invention could also be implemented through a third-party. As used herein, a cue shall mean any visual, audible or otherwise human or machine sensible item presented to a human or a machine to convey some information about any topic. A cue may be used to mean, for example, a visual representation shown to a person to indicate to him (through the person's recognizing the cue) that the sender of an email message is who he/she/it claims to be.

Furthermore, in yet another exemplary embodiment, the same invention can be applied to all forms of online systems not just to web-based transactions, but to all situations in which a computer (or the organization owning and controlling that computer) must be authenticated to a user. Several illustrative examples might include: (1) ATM (automatic teller machines)—in which case it is desirable to enable the user to know that the ATM machine is real and legitimate, not a phony machine that collects ATM card numbers and pin numbers, dispenses cash, and then gives the information to a criminal. (2) email systems—in which you want users to know that the sending party, computer, network, or organization of a message is truly the party, computer, network, or organization who claims to be sending it. (3) instant messaging systems (4) transaction networks, (5+) etc. Note that if a true hash function is used, it may be beneficial to implement it in such as fashion that there are intentional collisions. (i.e., there will be more possible hash values than actual cues so there will be some cues that will be produced for multiple hash values). This strengthens the protection of the hash for this purpose (i.e., if there are 2ˆ64 possible hash values we do not have 2ˆ64 cues—one might use fewer to ensure that there will be many inputs that will produce the same cue so that nobody can deduce what the input was from seeing a cue—even by brute force techniques, such as sending all possible inputs to the system). Regardless, of the particular application of the present invention, it should be noted that the actual implementation may be initiated or hosted by any party to a transaction or online activity, or even by a trusted third party.

### DRAWING DESCRIPTION

FIG. 1 is one example of a general connectivity scheme between some illustrative elements involved and actors utilizing the present invention;

FIG. 2 is an illustrative flow diagram detailing some steps and potential routines involved in executing one implementation of the inventive method and system;

FIG. 3 is a continuation of the illustrative flow diagram detailing some steps and potential routines involved in executing the inventive method and system beginning in FIG. 2;

FIG. 4 is illustrative flow diagram detailing some steps and potential routines involved in executing an optional armor code embodiment of the inventive method and system;

FIGS. 5A and 5B are illustrative flow diagrams detailing some steps and potential routines involved in executing some possible forms of interaction between the transaction entity and the user when the user sends information and/or values within the general scheme of the inventive method and system; and

FIG. 6 illustrative flow diagram detailing some steps and potential routines involved in executing the log and transaction monitoring function within the inventive method and system.

FIG. 7 shows a flow diagram of one example of the invention as might be employed in an email system in which a mail server running the invention is used with mathematical calculations to add representations to emails to users to prove the identity of the sending organization;

FIG. 8 shows a flow diagram of one example of the invention as might be employed in an email system in which a mail server running the invention is used with mathematical calculations and a database lookup to add representations to emails to users to prove the identity of the sending organization;

FIG. 9 shows a flow diagram of one example of the invention as might be employed in an email system in which a user or mailing application calls a routine on the server to add the representation to the email; and

FIG. 10 shows a flow diagram of one example of the invention collecting data related to a login from a user's computer before the user has attempted to submit his information to the application/web server and login, and example of the use of such data in an attempt to bolster security which might take place within the systems detailed in above diagrams.

### DETAILED DESCRIPTION

In its broadest description, the present invention is both a method for on-line identity authentication for an electronic system, comprising the steps of receiving user related values or identity indicia (the term identity indicia and/or user related values as used herein is intended to include all manner of information that could be employed by a user or a machine to identify a user or machine, including but not limited to, a user ID, an email address, an ATM card number, password, or any other related or unrelated information, such as the novel “Armor Code” referred to herein—or portions of such fields) from a user (or from a server—such as transactional/source information and/or a certificate such as an SSL certificate, or other information known in other situations that either represents some information about the user, about the server, or about both), generating a mathematical value based on this information and the application of some function (e.g., a one-way mathematical value, such as the exemplary hash generated value as used herein throughout) based on said user related values, generating at least a portion of a user friendly representation of said mathematical value (e.g., via an exemplary one way hash value), and communicating to said user said at least one portion of said user friendly representation upon said generating of same, and a system for accomplishing the same through the means described herein. The invention also includes the concept of scanning logs, transactions, and/or activities on both business systems and the invention itself (which is itself also classifiable as a business system) for suspicious activity in an effort to take action and prevent phishing and other related and unrelated fraud. Thus, the invention is, inter alia, a double-layered anti-phishing solution that prevents fraud such as phishing from occurring in the first instance, and also reduces the possibility of damage to users who may have been phished (or to organizations whose users have been phished), in the unlikely event that the initial protections described herein are defeated or otherwise not employed. Furthermore, an instantiation of the invention would also be a system that inspects the logged activity and analyzes it in such a fashion to determine if the current login matches the known past behavior of the user, and if there is some suspicious of problems—it may ask for some further authentication information prior to delivering a visual/audible cue, may notify a system administrator, or may take other corrective/notificative action. The initial protections are such that the inventive system and method provides for employment of the described protections when the user initially sets his user or machine related value (typically a user name and password, an email address, an ATM number, although other information (whether related to the user or even to the server authenticating itself to the user—e.g., the server's SSL certificate) may easily be considered within the scope of the invention and an Armor Code or set of Armor Codes may be used) with a given computer system (i.e., transaction entity). Upon the completion of the setting of his user or machine related values or identity indicia, the proper, user-friendly (e.g., easy to recognize as familiar) representation (most preferably visual or visual combined with audio, although additional representations, such as audio or other means may also be utilized) of a mathematical value is generated based on that identity indicia or associated string of text. If the initial (or, if the user changes his credentials at any time in the future) setting is done online it will appear immediately, or if it is set by a help desk representative, then the representative would see the representation and would be able to notify the user as to what representation he may expect to see. Accordingly, when a user initially registers with the online system to become a “known” user (and for each existing user after the system is initially deployed) the user will be able to enter text and will then be shown an easy-to-recognize representation (or hear a sound/words/etc or both) that will be easy to remember, and will remain constant until any changes are made to the identity indicia (e.g., subsequent change of name, password, etc.). If changes are made to identifying information (e.g., if the first few characters of the password are used within the calculations and the user changes his password) then on the screen in which the system confirms to the user that the changes have been made it should show the user the new representation (e.g., “You have successfully changed your password. The new cue that you will see each time you login to this system is <whatever the cue should be>”. Furthermore, the cue could be displayed on every page shown to the user as he uses the system, and could be placed in emails sent from the system to the user. The representation may be shown to the user in web browser window, via email, or through any other means. If an Armor Code is used the user will have the opportunity to test text to see/her the appropriate corresponding representation. However, it is important to note that neither the text he chooses, nor the resulting mathematical value and representation are stored anywhere on any computer. It is likely that calculations should be done on the server side (although they can also be done client side on the user's computer) with the exception of if general software were to be created that created a cue based on SSL Certificates and user information it could be done as a browser plug in or other client side software. If an Armor Code or other text is used, the user may in fact remember the representations for as many different strings of text as he wants and may not have to use the same one each time he test the system; similarly, a user could test the system and check that the correct corresponding representation is displayed with a password that is not his genuine password for login purposes, and after verifying the correctness of the representation go back and enter his correct password. The representations also let users know if they have mistyped passwords or other fields that may be “starred out” (in which stars or some other characters or no characters appear as the user types and not the actual characters that were typed)—as if the wrong representation appears the user can retype to see if he made a typo before assuming the system is a fraudulent one. Also, if entries are false, then a false response step and means may be provided for so as to mimic a response to correct input so that a fraudulent user cannot determine whether a response is valid for a particular application or not.

In one preferred embodiment, when the user logs into an online system employing the inventive system and method, he will enter the same text before entering his user ID and Password (or whatever else he used for authentication, for example: UserID, PIN code and one time password, biometric information gathered through a biometric reader, smart card info gathered from a smart card reader, or any other input garnered from any form of reader) and will be presented with that same easy-to-recognize visual/audible hash representation. Alternatively, the user may see that information as he enters his user ID and password. (in which case it is possible (and sometimes preferable) that not all of the characters in each of these fields need to be used for the calculations just some of the characters in each). In either case, the mathematical function could initially be calculated after several x numbers of characters have been entered (either the entire user ID and some in the password, just the user ID, just from the password, from an Armor code, etc.) and then repeated (either using the same function, a different function, with the same or a different key/seed value—the key could be implemented as a classic key or could be simply text appended/mixed in with the text to be run through the mathematical function) after each additional y number of characters. The key could also be text applied through the function before any of the input from the user (or afterward or at any other point) if the function will accept such an action as mathematically correct. Alternatively the key may be used with a separate encryption algorithm before running the hash (or other) function. The encryption could use any available encryption technique. (In such as case the encryption algorithm could even be a simple algorithm such as a derivative of transposition or shifting.) Other “key” implementations may also be possible. The visual/audible representation would either be replaced after each subsequent hash calculation with a representation of the new hash result, or would be “built” with additional elements added after each calculation. For example: the first representation could be the outline of a shape, the second a color filling for the shape, the third the outline of a letter on top of the shape with a white/black filling, and the fourth a color for the letter. Or, each has calculation could add a digit to a number, e.g., after the first hash one digit is displayed, after the second digit is appended to the first digit, etc. Hence, the hashing will be done on the fly for each given identity verification attempt (i.e., log-in), so that identity indicia such as a user ID and password or text information might be entered online by the user, and as the keystrokes are received by the transaction entity (in many cases, a transaction entity will typically be a financial institution or other organization with an on-line presence, although many other institutions, such as service providers of all types, commercial or medical concerns, etc., are all entities contemplated within the scope of the possible applications of the present invention) the representation for his identity indicia (user ID and password, etc.) combination will be progressively displayed as confirmation is established in an iterative fashion. This could also be done on the Armor code or any other information. As described earlier, databases could be kept of chosen representations and functions used to generate them for users who have not chosen one. All communications (or some) between the server doing the mathematical calculations and representation generation and the user's machine could be encrypted for security reasons—even on top of standard SSL if someone so desired.

One of the important aspects of an embodiment of the present invention is to represent mathematical values (including those derived from mathematical functions such as one-way mathematical functions) in the form of something user friendly, like an image or audio. To this end, the present invention converts an ostensibly non-user friendly mathematical value into something that can be easily used, consciously or subconsciously memorized (committed to long term memory either through conscious effort or without it as is often the case with visual items), and later recognized by a user. To this end, a simple visual representation system such as colored letters, numbers, symbols, or pictures, etc. on colored shaped backgrounds simplifies the experience for users, makes remembering the proper representation easy, allows for technical support to provide similar authentication over the phone when resetting passwords (and provide the new hash representation after resetting), and facilitates building “images” based on the sequence of hash values as users types in words. Alternatively, numbers could be “built” or words used, but any visual representation will work, and to this end, other potential representations of the methodical value might, in alternate embodiments include a simple background color (with or without changing the color of text on the display), changing the color of the text on the display, showing a word(s), photograph(s)/cartoon type image(s), or even multiple representations or combinations of the above. Even buttons on the screen could be modified. Any visual change to what the user sees can be used as part of the invention. Similarly, an audible representation could be used (different tones, sets of tones, song snippets, “spoken” dictionary word etc.) in alternate embodiments, through computers or phone-based systems. Many other possibilities exist. The point is to use some easily human-recognizable and distinguishable representation of a mathematical value (or from a database) to prove that the party on the other side of a conversation or online verification process is the entity that it claims to be. In one preferred embodiment, a very simple single character visual representation (such as a colored letter, number, background, or simple geometric shape) is used, perhaps in combination with a “spoken” dictionary word or colored background, so as to minimize the extent of the visual representation that must be memorized by a given user, although more characters, elements, gray scales, fill patterns, or color ranges may be employed as desired. Either way, by employing a user-friendly, easily remembered/recognized representations, a simple visual representation uses human psychology to its advantage, given that simple visual representations—like colored letters or a colored background—are easily remembered or at least recognized as familiar by most humans. The same is true for some audible representations, and the combination of both visual and audible cues makes easier recognizing whether the response presented to the user is, in fact, familiar. Despite this apparent simplicity though, the numerous combinations possible within such a “simple” scheme, do not pose security risks like maintaining lists of passwords (especially if such passwords are presented to users prior to full authentication) as other prior approaches often do.

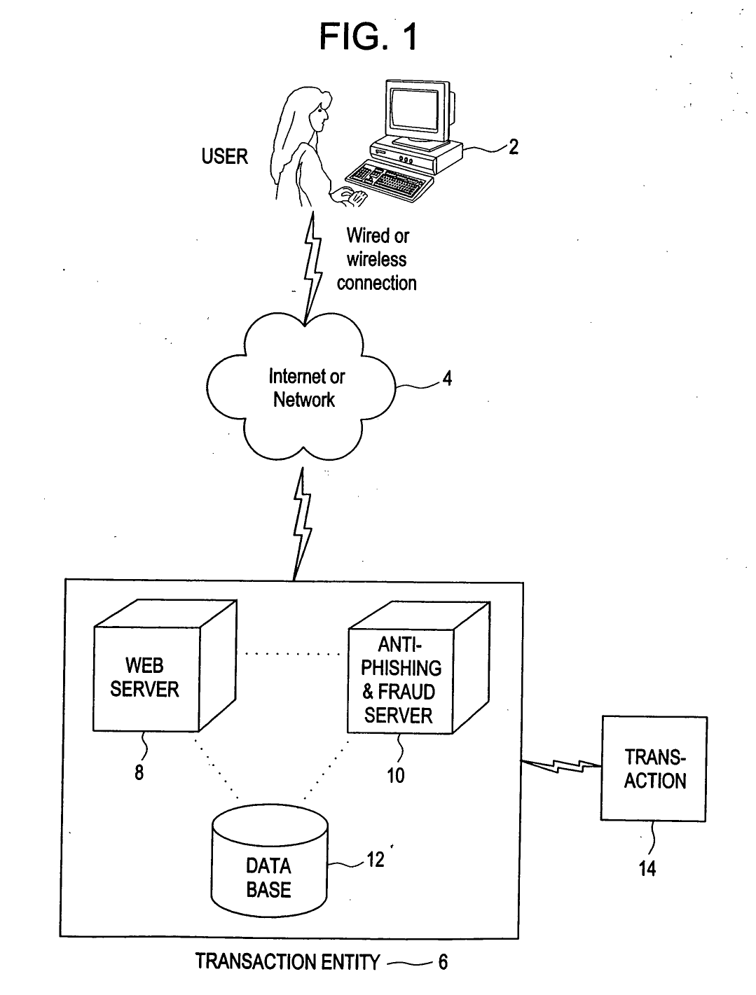

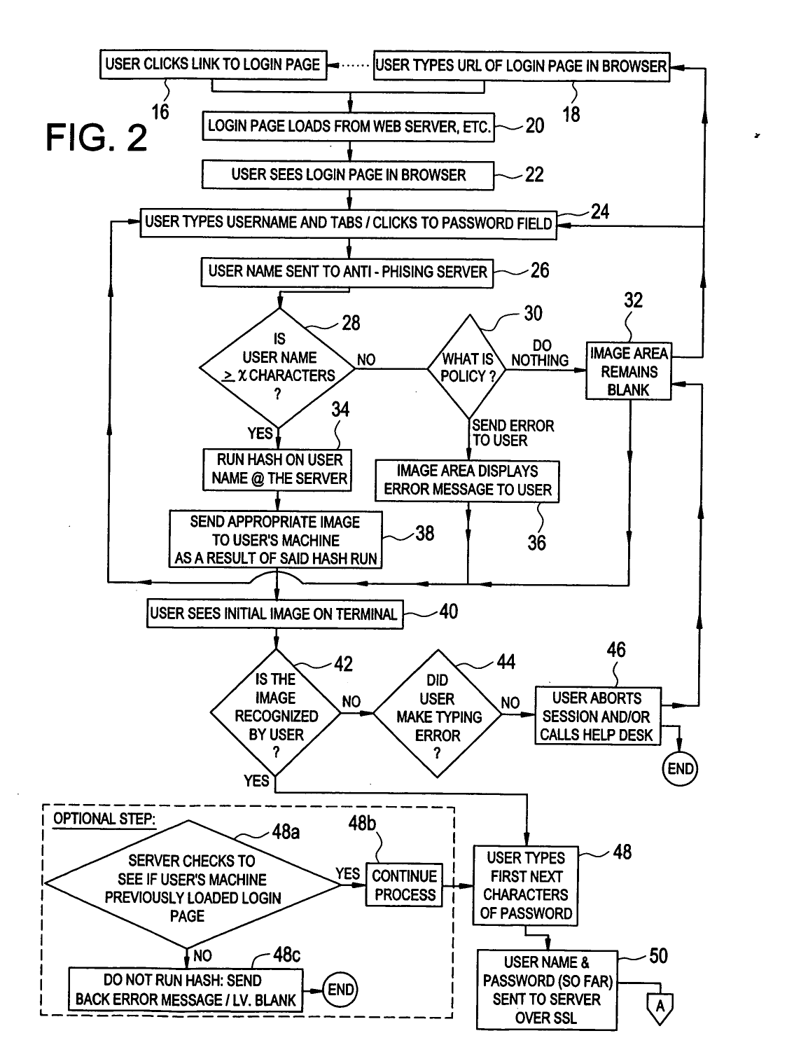

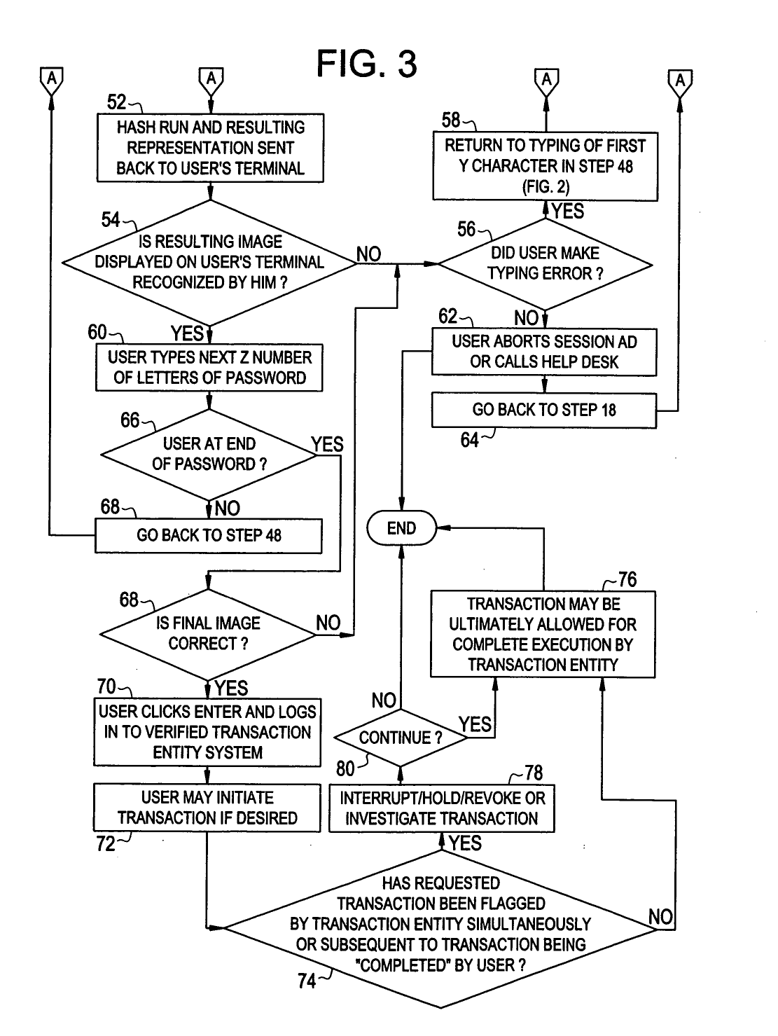

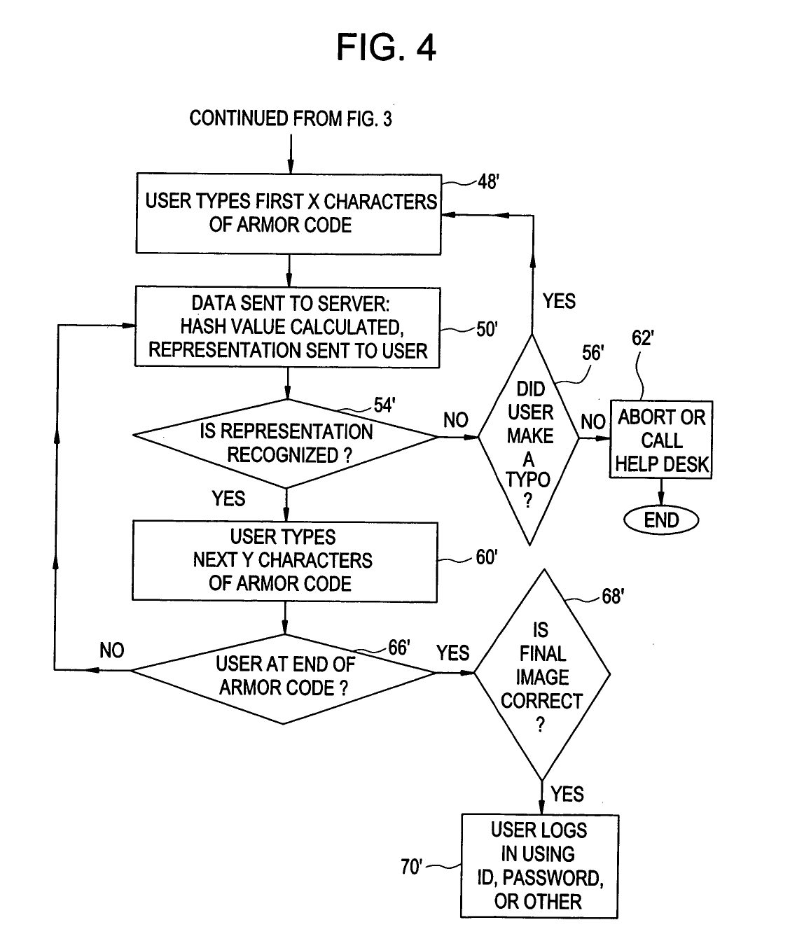

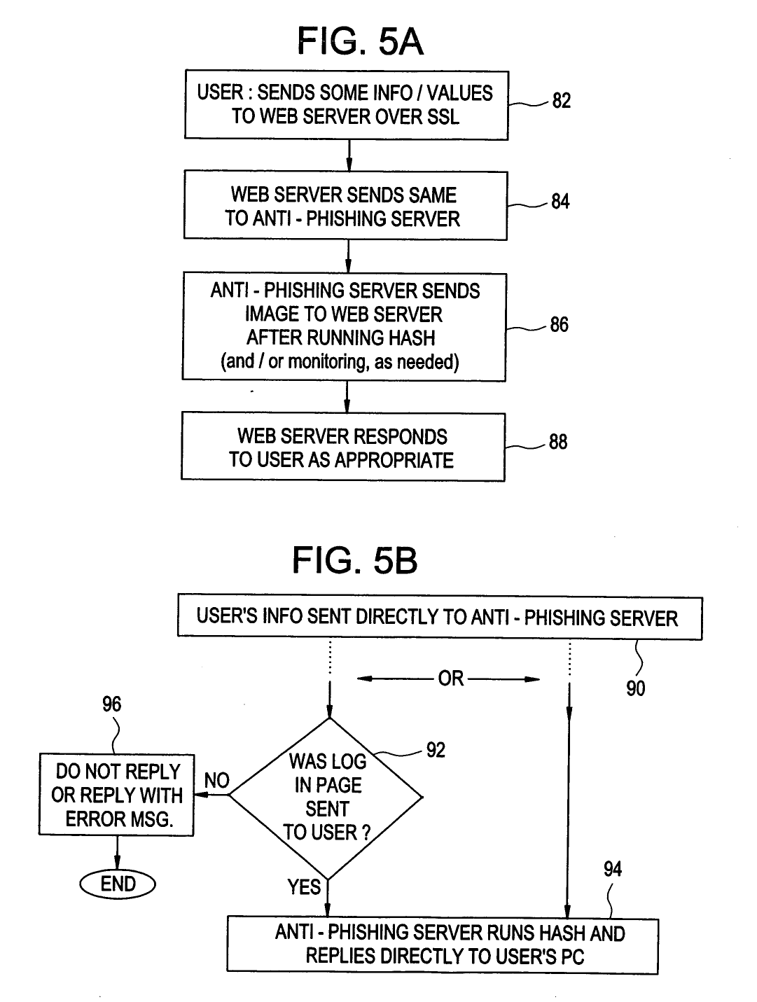

In order to accomplish the above, as one example of a possible implementation, FIG. 1 depicts how the user 2 may interact with transaction entity 6 through a network means 4 so that both actors receive and transmit respective signals from each other as generally illustrated in the illustrative flow diagrams in FIGS. 2-6, which may include optional variants therein. Some variants are depicted in FIGS. 4, 5A, 5B, and partially within FIG. 2. As understood, these signals and the processing as described herein represent the technical effect of transforming user and transaction entity security needs into a seamless, verifiable reality. By way of general reference, the overall process of the present invention may be seen in of FIGS. 2-3, which exemplify how the inventive approach will protect users from being phished, or subject to other variants of fraudulent activity. In its broadest description of this particular example, these flow diagrams depict illustrative steps wherein: a user loads login page; a user types his login name; a mathematical function is then run on a portion of his login name (while the data and the information about the function used, the date time, and sending machine is also logged and inspected behind the scenes for problematic situations); a visual representation is displayed to the user; a user recognizes the visual representation (and thereby continues the process), or alternatively, a user does not recognize the visual representation (and thereby aborts the process or contacts customer service); then, a user begins typing his password such that after x number of characters (which in one preferred embodiment may be 4 characters, although other numbers may also be used), and then a mathematical function (perhaps the same one, perhaps a different one, perhaps the same one with a different key) is run on the y number of characters representing the entire text already submitted including the user name (or on the portion of the password already typed) so as to continue progressive verification by sending further visual representation details so as to build out the overall visual representation so that the user may thereafter continue with the log-in and effectuate transaction as he deems appropriate, although as one skilled in the art will appreciate, this is just one example, and it is possible to readily modify the invention to many other possible variants of the present invention.

Accordingly, only the user (and not the server, nor the browser software) knows if the representation (image, number, word, letter, background color, sound, word read, music clip, etc.) displayed and/or heard is correct (in the case of a representation stored in a database the server may also know), thereby eliminating the chance that fraudulent actors might access a cache, hard drive, or other storage facility for passwords or other protection keys. In fact, the user need not remember exactly what the representation is as he would with a password or pass-image, but, rather, just be able to determine if what he is shown is familiar to him—i.e., has he seen it before when logging in. The science of human learning plays an important role—as humans in general recognize simple visual elements as familiar without having to actively memorize them. To this end, the mathematical value is generated using a function and secret key available only to the legitimate server (the key may be implemented as simply as a string of text added to the text the user submits or using other mechanisms as described earlier) and would be the same each time the user logs in: if the representation is the one the user expects, then he knows the system is authentic, (the key may be stored in encrypted form or otherwise protected on the anti-phishing server). The representation may be progressively formed or built out through an iterative or recursive function, that is, a routine may be provided whereby the mathematical function could be applied to the user's ID (or a portion thereof) and password (or a portion thereof) as he types (starting with the aforementioned several characters of the password) and he could watch the image being built as he goes. When provided as such, it is possible to utilize a user related values gathering module so as to receive user related values (e.g. SSL certificate, etc.) even before the user inputs information. If any steps along the way are not correct (e.g., the shapes/letters, colors, etc. are not what the user remembers them to be or he simply does not recognize them as familiar) then the user knows to stop typing, as the identity of the transaction entity is not confirmed. (There may be a message to this effect on the login page and the user will be educated to this effect when he initially logs in and a message instructs him to this effect. Periodic reminders may also be sent to him on bank statements, health insurance benefits statements, and other correspondence. Furthermore when the system is initially implemented the representations could be provided to users AFTER they login with a message that starting on some future date (or even on the next time that they login) the prerensetations will be presented during the login. On such a page the representations could be displayed in stages—i.e., built—or could be shown as complete images (or sounds or both).) An image may be built as the user types (and the user would therefore see it have additional elements added as he types more characters) or after he has finished entering data into the field in questions. In one preferred embodiment, after the user neters his username (or first few characters of his username) a colored box appears. After the user enters first four characters of his password: image items are added to the colored box (colors, patterns, letter, etc.) after every few characters, wherein all elements may be based on one-way hashes or other mathematical functions or even some database lookups or a combination thereof. In another embodiment, the mathematical function or one-way function is called only once—and resets the color of the background of the page. In another it is called twice—once to set the background and once to set the color of the text (which is also influenced by the background color—i.e., the actual color range for each value changes based on the background). Other objects could also be modified in other manners to communicate to the user that the site is familiar and authentic in a manner that the human will easily and quickly recognize—i.e., as a form of human friendly representation. The inventive system and method uses software routines to generate a series of mathematical functions that can be run either while the user types (e.g. for passwords), or alternatively, after the user types (e.g. for Armor Codes, as depicted illustratively in FIG. 4 The Armor Code is not a special code, but rather the name we are using for any text the user chooses to use for confirming the identity of the server with whom he is interacting. The user types the string of text and the function is run on the text and the resulting representation presented to the user. Armor Code allows the user to test for system authenticity, even before typing his login name. It also allows one consistent entry and one consistent representation across multiple systems using different authentication types, values, or information. In one embodiment, the mathematical algorithms are hash algrotihms that include unique keys added to the text to be hashed or used for a simple encryption scheme before performing the hash, or, if the algorithm used for hashing allows, in initialization vector-like starting values/keys. The use of a server-based key as depicted herein is such that even if an external party knows the nature of the hash function being used, he will be unable to figure out what the valid representation response is for any given user or input. Furthermore, which bits of the actual mathematical value should be used for creating a representation can also be configured or set in a (same or separate key). It should be noted that the hash function could be applied against a dedicated text field that is not a username or password (e.g., the Armor Code), but which is used for the sole purpose of checking the legitimacy of the system before entering any credentials. The present invention may further provide for a (separate or same) key that contains the server name, IP address, network name, etc. for licensing and security reasons. This key ensures that even if hacker stole the key, anti-phishing/fraud system, and the initialization key, he would not be able to use it, because the licensing key would prevent the server from running on machines other than those at the legitimate institution (or at least would make it very difficult to do so in a manner that the legitimate institution would remain unaware of its being abused in such a fashion). In terms of licensing reasons, the key is afforded so that the inventive solution cannot be used on unlicensed servers so as to prevent software piracy and its associated losses. Further included is a monitoring module which tests for the presence of possible fraud by examining activities that transpire. For example it may examine what is typed on a user's computer before the user attempts to log in by pressing SUBMIT (or any other way of transmitting credentials to a system) after entering his or her login credentials (as it collects information to generate the human-friendly representation), it may look at activities that the user performs after logging in, it may look at past patterns of activity, it may look at demographic information, it may look at many other items obtainable before and/or after a user logs in and begins using the system. The invention also includes a flagging module and means for flagging any irregularities or suspicious patterns detected and any alert computers or humans through one or more of numerous means (email, page, console, web page, warnings, beeping, etc.). The invention includes the use logging of activities that transpire before users login to a system as well as afterward (and other activities) for the purpose of checking for suspicious patterns, combating man in the middle attacks, and other purposes. It includes logging of which identification information were used for generating cues (perhaps stored in a different hashed format for security reasons). In the case of email-based visual or other human friendly representations it may include creating a log of which addresses have received human friendly representations, who the senders were, what date and time messages were sent, etc. The flagging is done so system administrators, security personnel, auditors, or other parties—may be able to take action. Users may also be informed to take action (or to prevent specific actions from occurring in the future). Also included is a user related values module and means for gathering user related values such as usernames, email addresses, etc. even before the user inputs any information or in situations when users do not input the information such as when sending email. Furthermore, the invention could be implemented in a method and module in which users can select what visual, audio, or other representation they want to see and the information is extracted from a database. Furthermore, the invention could be implemented with a module and means to allow users to select a representation, but if none exists for a particular user then the representation is generated mathematically as described above. Furthermore, the invention allows any combination thereof.

Those skilled in the art will appreciate that the present invention is flexible enough to provide for a trade-off between simpler representations (typically offering somewhat less protection from impersonation by phishers and/or other parties) and more complex representations (typically involving relatively more security). It also provides tradeoffs as to what the representation runs on—e.g., a username, or a username and password or portions thereof. In this example, for example, the earlier the user sees a representation the earlier he or she will know if the system is real—doing so before typing any portion of a password is ideal. But, generating a representation based solely on a username is a problem, as usernames are not necessarily secret. However, even with a very simple implementation of the invention by which the background color of the user's display is changed to one of 16 basic colors after running a single has function, there is a 93+% chance that the site cannot be properly impersonated. As representation grow more complicated the likelihood of a phisher successfully impersonating the legitimate site approaches 0, especially since if short words are used as text within colored boxes (and the words themselves colored) criminals would not know what the list of possible words are—meaning that many millions or billions of possible representations may exist. The more noticeable the modification to the login page (or other user experience components) the more likely that the user will notice. Within this framework, another configuration of the representation would be to use a visual representation involving approximately: 16 shapes; 16 colors/patterns; and 36 alpha-numeric characters (or 32 if one were to eliminate some of the characters due to confusion—e.g., the letter O and the number 0). Another set may consist of two and three letter words or letter combinations (e.g., ABC). The text may be colored as well as part of the representation. A combination of multiple types of representations could be used on a single implementation of the invention. Such a range of possible variable elements means many thousands representations at a minimum, not counting possible further variations with background colors, audio, other characters, advanced colors/patterns, angles of rotation, multiple letters, etc. More complicated representation schemes with additional variable components may be used. Thus, the total configuration can be scaled to enormous numbers of possible combinations, thereby rendering impersonating of the same practically impossible, yet simple enough for a user to both recognize and use on an ongoing basis (thereby obviating concerns about technological and/or practical shortcomings of known anti-fraud systems).

As mentioned, the present invention is applicable to additional on-line verification/anti-fraud applications. One such additional application is to combat those fraud techniques covered under the name “man-in-the-middle.” In combating man-in-the-middle problems, it is useful in one embodiment to afford the following within the scope of the inventive system: restricting the serving of images to IP addresses or machines (as determined through cookie usage) to those that have already requested the login page; tracking the number of different unique hash requests per IP address, utilizing “cookies,” and using public/private keys (in order to make it impractical to broker requests). When used in this manner, these technologies can also prevent hackers from trying to obtain list of hash codes by issuing repeated hash requests, thereby combating some brute force attacks (although it must be noted that the invention herein does not require any saving of sensitive data (e.g., passwords) on the transaction entity server, and that to be effective for phishing would require generating a very large list of hash results that is likely impractical to do even without these technologies in place.). Moreover, it will be appreciated by those skilled in the art that certain aspects of the continuum described herein may be utilized individually for other applications (e.g., the log, activity, and transaction monitoring may be utilized by itself, if desired, to monitor various forms of fraud, while the initial log-in verification stage may be used for other purposes as needed. Furthermore, as part of a way to combat the man-in-the middle issue the invention could be configured not to generate representation except to trusted computers as defined by the presence of a cookie, registry key, specific IP range, etc.) This also adds an important element to the invention—the ability to perform rudimentary two-factor authentication—by allowing only users on specific machines to be able to see the visual representations—or, if the organization using the invention desired, to login altogether (as the system could block the login page from loading in addition to not generating the cues).

In this regard, the present invention is not limited to a “one-shot” approach to identity verification, in that it provides a true continuum of identity verification, beginning with the initial verification described above, and continuing with verification of identity veracity for the issuer of transactions/activities before logging in, during, and after the pendency of any transaction/activity that may have been initiated as a result of the identity confirmation at the initial stage or in spite of it or prior to its implementation. It may also implement rudimentary two-factor authentication as described earlier in order to provide stronger authentication of users. Note that the first identity verification is the server to the user, while the second is user to server, thereby offering a fuller scope of protection. Hence, in the rare cases where a fraudulent actor may have been able to trick a user through any means (phishing, social engineering, or otherwise) to surrender to him sensitive access credentials, the present invention will conduct transaction/activity/log monitoring by monitoring logs/activities/transactions and/or the nature of the individual or aggregated transactions themselves to provide an extra level of protection against fraud. Furthermore, the system may be able to prevent some access by unauthorized parties who may have gained access through tricking a user through any means (phishing, social engineering, or otherwise) to surrender to him sensitive access credentials, as the actor committing the unauthorized access may perform various actions before logging in that may not fit the true user's normal sage pattern.

The method, means, and concept of combining of front end and back end protection against phishing is contemplated within the invention and has been described illustratively. As is obvious from the method of generating representations based on the result of mathematical functions (i.e., without looking in any user databases), the invention also includes the method and means to generate representations for all input by all users such that even if information that is supposed to be a username is submitted and it is not a valid username on the actual back-end application the system, will generate a response. This part of the invention has security benefits as it prevents anyone from verifying whether a specific username/password is valid by simply checking for a response with a representation from the system. In fact, the invention is more general in this regard—the concept, means, and method for responding to requests with invalid input in order not to disclose potentially sensitive information is part of the invention. Even if a database were used the same would hold true—we could generate mathematically for any input not in the database (generating randomly is no good as it would cause the same input values to produce different results from invalid logins and the same values to produce the same results each time for valid logins so it would still allow people to determine the validity of particular logins). The method, means, and concept of delivering responses even to invalid input that exactly mimics the response to valid input in such a fashion that it becomes impossible to tell what is valid and what is not has many other applications.

Regarding the initial identity verification (as opposed to the activity monitoring), the system described as such will also guard against both man-in-the-middle attacks (in which the phisher has users come to his site and relays specific data to the real server in order to obtain the correct responses), and situations in which phishers attempt to generate large hash result tables using brute force techniques. To this end, the inventive system and method could monitor and act upon unusual usage patterns (for example, by identifying many requests from the same system with different values to be hashed). By way of illustration, there could actually be multiple forms of man in the middle attacks—a couple of examples include: the classic case described above, and one in which the criminal attempts to deliver a phony login page from his server (or a phony email from his server), but generate the proper representation from the real server. This can be stopped using multiple different technologies—for example using frames within the login page to deliver a visual representation over the web and configuring the server to allow only access to the generator from that frame referred by the original server from which the frame is loaded. This is one example of how to protect against this type of fraud—there are many others as well. In the email world, if the invention is run on a special mail server that adds cues to all outbound emails passing through it, that server can be configured to only accept messages from specific machines, networks, and users—at specific times—over specific connections, etc (either using a system implementing the invention or with a standard firewall). All inbound and outbound ports—other than needed for mail transport—can be blocked.

Thus, the log scanning/transaction monitoring/activity monitoring is an additional important feature of the present invention, and may even be applied to many forms of online fraud beyond phishing, and may even be just used to see if any phishing activity has occurred, regardless of user involvement with the above-described log-in verification. Because the inventive approach provides for the scanning of transaction and activity, logs to detect suspicious activity in a given or over a multiplicity of transactions (including the logs of the invention itself with information about what transpires on a user's computer before he actually submits his login information to authenticate himself to the server), it is akin to an “identification” for phishing and other forms of online fraud. Because it detects phishing or other fraud (e.g., the obtaining of user credentials through phishing) after it has occurred (but possibly before fraudulent transactions or activities occur by criminals using the fraudulently obtained credentials) it affords both the legitimate user, and the associated transaction entity a true continuum of protection found nowhere else: in certain cases, the scanning may be scheduled to occur within the time period of a transaction pendency so as to be able to reverse or hold transactions with minimized loss (in the case of the invention's logs and certain other other logs this can be done to prevent unauthorized users from logging in altogether by running as the user attempts to login or after he clicks submit). Upon detection, an alert may be issued to appropriate personnel to verify the authenticity of the activity or transaction, the systems issuing the transactions or performing the activity may be blocked from future access, or other policies may be activated. The account with the transactions/activities may be locked to prevent further exposure. Additionally, the system can track a phisher (by obtaining the IP address from which the request was made and tracing the route back to it) shortly after crime so as to afford one a greater likelihood of catching the fraudster(s) involved.

Accordingly, by way of one illustrative example, if scanning of business activity logs is enabled, multiple transactions involving outgoing transfers of money (or other forms of “spending” that may form irregular patterns as understood by those skilled in the art of fraud patterns) may trigger a system alert, or cause specific IP addresses to be temporarily blocked as described above. This would work using one of several possible techniques. For example, in one exemplary embodiment, activity logs may be scanned periodically (perhaps several times per day, or more often as dictated by the needs and/or business of the transaction entity) in order to search for suspect activity. Examples of such activity and scanning would be looking for “outgoing” transactions from multiple accounts issued from a single IP address, outgoing requests initiated from addresses in one region when the user accounts are all in another region, etc. To this end, the transaction entity may set some predetermined rules or thresholds according to industry standards and entity needs that may be embodied as routines within the computerized system that will react when a set limit is reached or when a type of transaction occurs, etc. When the computerized system reacts to such a transaction or transactions as being suspect according to the predetermined rules therein, they then may be flagged. Once flagged, the system may disallow, restrict, or set aside the flagged transactions for further examination, such as by humans who might be able to examine them and determine if they are legitimate, or the result of someone having being phished or otherwise tricked into surrendering access information. Once such a determination has been reached, it may then be possible to allow the flagged transaction(s) to continue, or they can be continually/on-a-one-time-basis disallowed, rescinded, or set up for further verification (for example, by contacting the account owner to see if the transaction(s) were in fact made by him). This functionality is particularly useful in the case of certain transactions that may take time to “clear” because of industry custom or because of technological and/or logistical limitations (e.g., financial transactions such as securities sales, wire transfers, etc. that have settlement periods of a day, etc.), as those transactions may be further subject to a practical form of verification through the inventive monitoring whereby a fraudulent transaction may be revoked, investigated, etc. By contrast, however, the monitoring may be done on a real time basis in order to satisfy transaction needs. For example, in one embodiment, the present invention provides for the performing of a real time analysis of the transactions that occur, in order to check for legitimacy, so that anything deemed potentially illegitimate can be blocked, delayed, or subject to (possibly immediate) scrutiny by automatically notifying a human to look into the propriety of the transaction. The real time approach may be accomplished by either tighter integration of the anti-fraud/phishing system with the business systems or via reading the details of every activity/transaction from the activity logs as they occur rather than reading this information periodically as described earlier. Previous transaction information may be considered as part of the analysis process. Furthermore, it should be noted that the monitoring solution is applicable across verticals, as well as the logs of the inventive methodology itself with information garnered before the user logs in may further be included in this process.

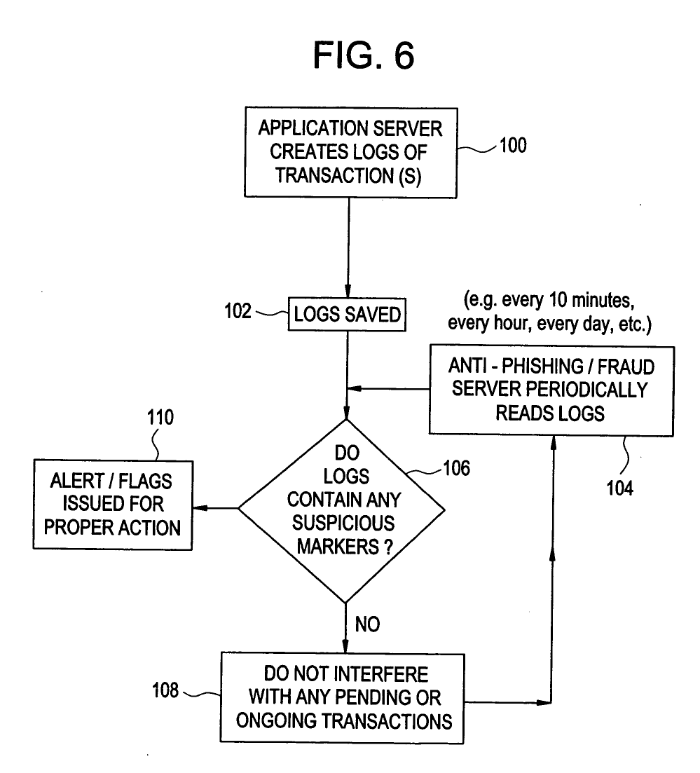

Thus, by way of illustrative flow diagram FIG. 6, the present invention is able to offer an exemplary approach to reducing the impact of fraud resulting from attempts by phishers and other criminals to exploit access information obtained through phishing, other forms of social engineering, or any other method. Criminals may attempt to execute the following steps: the user (criminal) performs a transaction using the online system; the transaction is logged; and the anti-phishing server periodically scans the logs and looks for anomalous patterns that may indicate phishing and/or other forms of fraud. Anomalous transactions might include patterns indicating transactions to effectuate outgoing transfers from different users' bank accounts made from the same IP address, (if not previously determined to be legitimate as in the case of a proxy and multiple users of a large corporation, which ideally should nevertheless be checked so that known proxies may be accounted for in the future if they are determined to be legitimate and to reduce the risk of someone issuing fraudulent transactions using a proxy address or through such a proxy). Other suspicious patterns might involve multiple requests for has representations from the same IP address (if not established as requesting such for a legitimate reason), and whether a given IP address has not recently loaded a log-in page (such instances may indicate fraudulent intervention within the process—including man-in-the-middle type issues, and as such, it is often best to avoid serving images to IP addresses that did not recently load the login page). To this end, if such patterns are detected, the transactions that are suspect are flagged and an administrator is summoned/notified to look at them (or other corrective actions are taken).

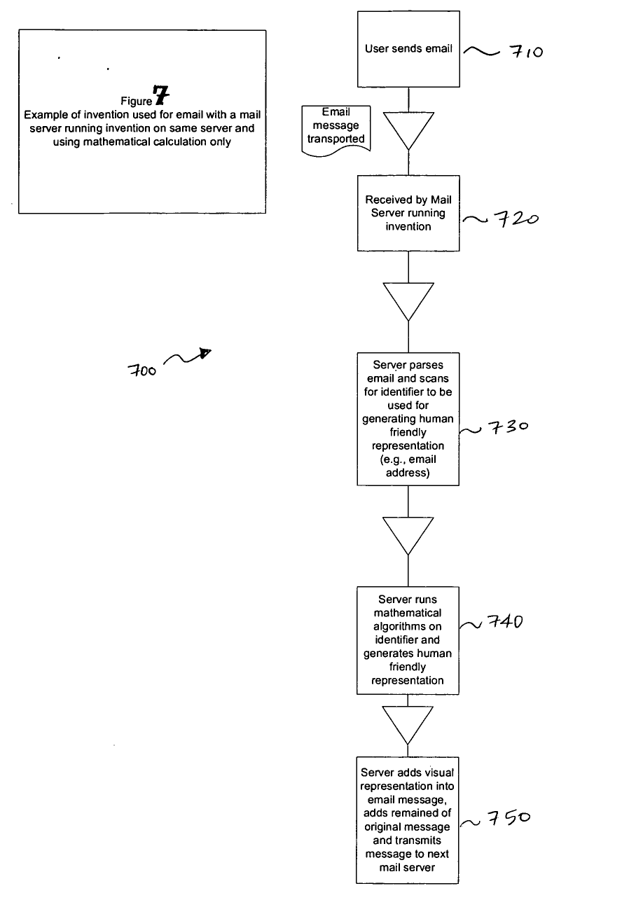

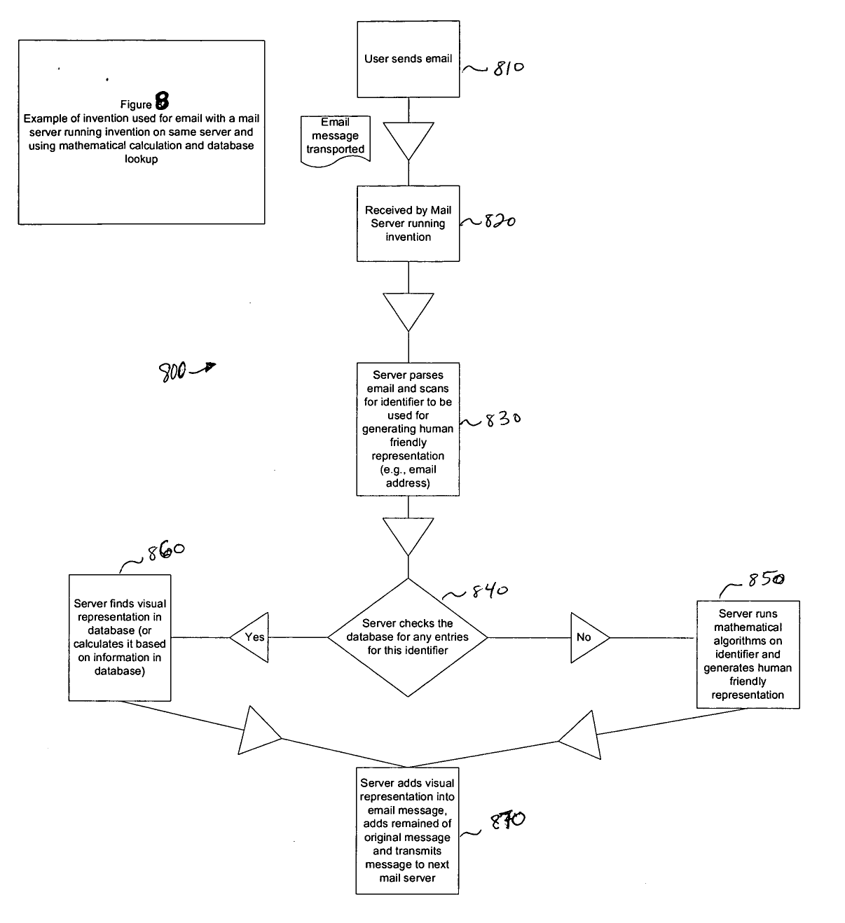

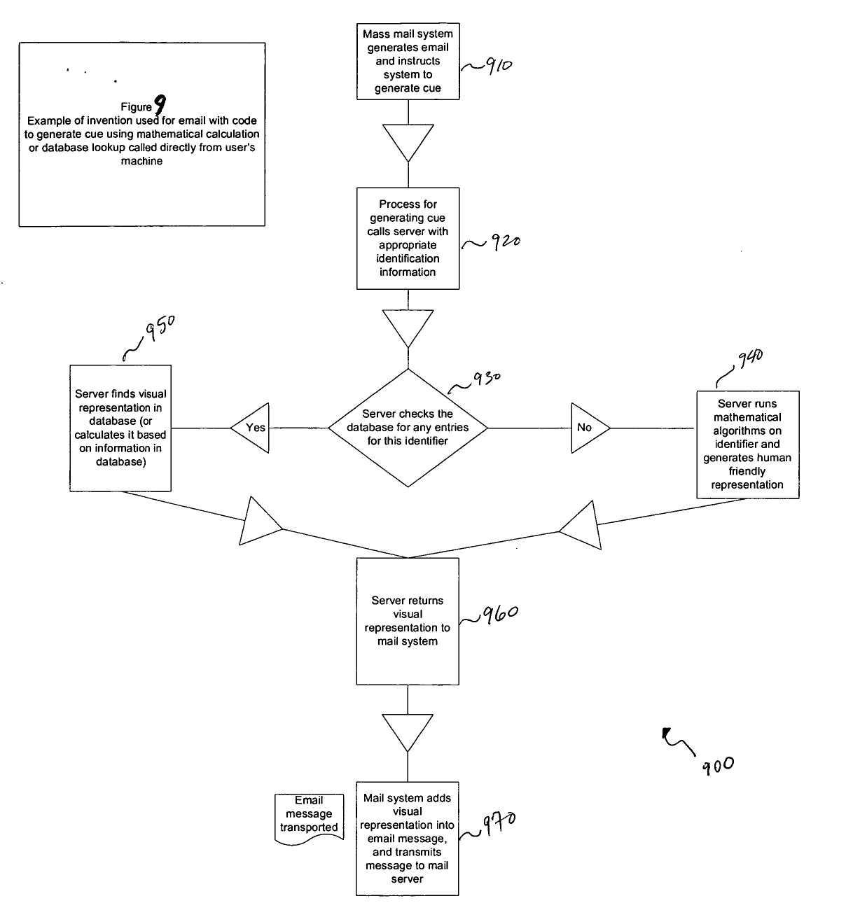

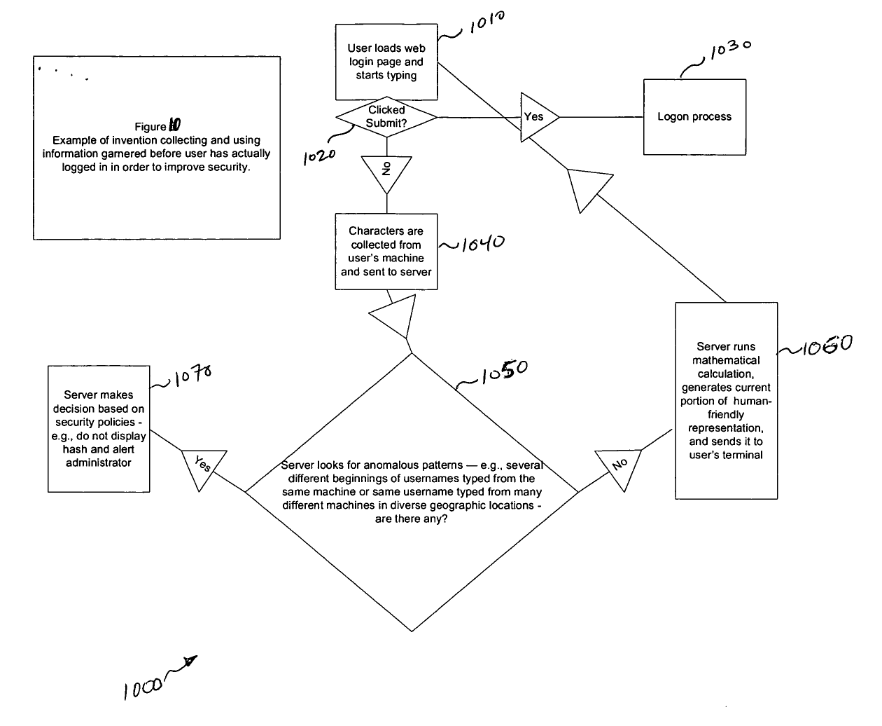

As seen, FIGS. 7, 8, 9 and 10 offer further illustration through general overviews of some of the exemplary email-related and security-related embodiments described above. In particular, these figures depict: an illustrative flow process for an email application 700 of the invention using mathematical calculation only (as configured through sample steps 710-750); an illustrative flow process for an email application of the invention on a mail server using mathematical calculation and database lookup 800 (as configured through sample steps 810-870; an illustrative flow process for an email with code application of the invention using mathematical calculation or database lookup called directly from a user's machine 900 (as configured through sample steps 910-970; and an illustrative flow process for a security application of the invention for collecting and using information garnered before a user has actually logged 1000 (as configured through sample steps 1010-1050.

Although known phishing scams have generally lacked sophistication in terms of combining their tricks with additional fraudulent techniques, it is nevertheless likely that phishers will improve their techniques with time. For example, it is conceivable that phishers might utilize pilfered versions of say, the inventive system. Another component of the invention is the ability to split the key used to seed the mathematical function into two or more components—in one example, one portion set by the deploying organization and one part built into the code by the supplier of the system. Additionally, the invention includes the idea and technology of running a check that a security system is running on an authorized computer by checking network (IP) address, physical (MAC address), looking for some specific registry or file settings, etc. These components of the invention would make unauthorized porting or usage of the systems using the invention difficult. The present invention further contemplates an enhanced utilization of the above-described inventive techniques, such that the inventive solution is, in an alternate embodiment, armed with the capability to combat the aforementioned future threats. Some of the techniques to combat such threats have been described earlier. Additional technologies that may be utilized to this end (and to combat man-in-the-middle and other potential attempts at fraud) include the use of: binding keys used for hashing to server names; checking SSL session IDs (perhaps encrypted); verifying IP numbers, comparing SSL certificate IDs to the ID of the server sending the image, utilizing cookies, checking browser types, checking how many requests for different user-names (or other user identification information) came from the same computer or network, seeing if users are logging in from machines that do not conform to their usual usage habits (e.g. logging in from a machine in Latvia when the user always logs in from New York City where he lives), etc. or a combination of these techniques and/or other techniques.

Another instantiation of the invention would be to ensure identity of a system (or even the person or entity on the other system) that has sent an electronic message (i.e., email or instant messaging message, etc.) to a user. In this instantiation a user/organization/computer that wants to send a message to a user and allow that user to know for certain that the message was actually sent by the sending party would run the hash (or other mathematical) function on some user-identification information and add a visual representation (cue) to the email message. In one instantiation the mathematical function would be run on the email address of the recipient and the cue added to the body of the email. The cue would be the same for all emails sent by this particular party to this particular user. When the user originally registers with the online site the cue could be shown to the user (on a web page or via email or some other mechanism) and he or she would recognize it as familiar when it appears on each email. Other methods may also be used to initially show the user the cue to the user.

It is to be understood that the invention is not limited to the illustrations described and shown herein, which are deemed to be more illustrative of several of the anticipated best modes of carrying out the invention, and which are susceptible of modification of form, size, and arrangement of parts and details operation. These modifications are within the spirit and scope of the appended claims.

I claim:

1. A method for representing a mathematical value in a human-friendly way for use in confirming authenticity within an electronic system, comprising the steps of:
receiving at least one user related value from a user;
generating a mathematical value based on said user related value;
generating at least a portion of a user friendly representation of said mathematical value;
communicating to said user said at least one portion of said user friendly representation upon said generating of same.

2. The method of claim 1, wherein the step of generating the user friendly representation of said one way hash value comprises the step of generating a visual representation through a user terminal, upon said communicating of said at least one portion of said user friendly representation.

3. The method of claim 2, wherein the step of generating said visual representation for display on said user's terminal upon said communicating of said at least one portion of said user friendly representation further comprises the step of generating said visual representation as at least one of the following chosen from the group comprising geometric shapes, letters, numbers, freeform shapes, words, letter and/or number combinations, and pictures, or other visible items or objects.

4. The method of claim 3, wherein the step of generating said step of generating said visual representation further comprises the step of generating at least one of the following comprising a color or a pattern associated with at least one of said visual representations.

5. The method of claim 4 further comprising the step of associating transactional, activity, behavioral, log and/or source information with said user related values.

6. The method of claim 5, further comprising the step of monitoring said transactional, activity, behavioral, log and source information associated with said user related values, for the existence of possible fraud.

7. The method of claim 6, further comprising the step of flagging any possible fraud as determined during said step of monitoring said transactional, activity, behavioral, log and source information associated with said user related values for the existence of possible fraud, for disposition in accordance with predetermined rules.

8. The method of claim 7, wherein said user related values may be retrieved before users have actively submitted input to a given site.

9. The computer readable storage media that contains a program that when executed by a computer represents a mathematical value in a user friendly way for use in confirming authenticity within an electronic system by performing the steps of:
receiving at least one user related value from a user, said user related value comprising a server certificate;
generating a one-way mathematical value based on said user related value;
generating at least a portion of a user friendly representation of said mathematical value;
communicating to said user said at least one portion of said user friendly representation upon said generating of same.

10. The computer-readable storage media of claim 9, wherein the step of receiving said user related value from said user further comprises routines for providing an iterative reception or single time reception of said user related value from said user based upon a continuing recognition of each of said at least one portion of said user friendly representation upon said generating of same.

11. The computer-readable storage media of claim 10, wherein the step of generating the user friendly representation of said one way hash value comprises the step of generating a visual representation through a user terminal upon said communicating of said at least one portion of said user friendly representation.

12. The computer-readable storage media of claim 11, wherein the step of generating said visual representation for display on said user's terminal upon said communicating of said at least one portion of said user friendly representation further comprises the step of generating said visual representation chosen from the group comprising geometric shapes, letters, numbers, short words, letter and/or number combinations, freeform shapes, and pictures, or other visible items or objects.

13. The computer-readable storage media of claim 12, wherein the step of generating said step of generating said visual representation further comprises the step of generating at least one of the following comprising a color or a pattern associated with at least one of said visual representations.

14. The computer-readable storage media of claim 13, further comprising the step of verifying online activity veracity by associating transactional, activity, behavioral, log and source information associated with said user related values.

15. The computer-readable storage media of claim 14, further comprising the step of monitoring said transactional, activity, behavioral, log and source information associated with said user related values for the existence of possible fraud.

16. The computer-readable storage media of claim 15, further comprising the step of flagging any possible fraud as determined during said step of monitoring said transactional, activity, behavioral, log and source information associated with said identity indicia for the existence of possible fraud, for disposition in accordance with predetermined rules.

17. The computer-readable storage media of claim 16, further comprising the step of obtaining user related values before users have actively submitted input to a given site.

18. An apparatus for use in confirming authenticity within an electronic system, comprising:
means for receiving user related values;
means for generating mathematical value based on said user related values;
means for generating at least a portion of a user friendly representation of said mathematical value; and
communicating to said user said at least one portion of said user friendly representation upon said generating of same.

19. The apparatus of claim 18, wherein the means for receiving user related values from a user further comprises: means for providing an iterative reception of said user related values from said user based upon a continuing recognition of each of said at least one portion of said user friendly representation upon said generating of same, wherein the step of using user related values for a user comprises reading of said user related values from data known about the user.

20. The apparatus of claim 19, wherein the step of generating the user friendly representation of said one way hash value comprises the step of generating a visual representation through a user terminal upon said communicating of said at least one portion of said user friendly representation.

21. The apparatus of claim 20, wherein means for generating said visual representation for display on said user's terminal upon said communicating of said at least one portion of said user friendly representation further comprises a means for generating said visual representation chosen from the group comprising geometric shapes, letters, words, numbers, letter and/or number combinations, freeform shapes, and pictures, or other visible items or objects.

22. The apparatus of claim 21, wherein means for generating said step of generating said visual representation further comprises a means for generating at least one of the following comprising a color or a pattern associated with at least one of said visual representations.

23. A apparatus for verifying activity authenticity within an electronic systems by receiving user related values from a user and associating transactional, activity, behavioral, log and source information associated with said identity indicia.

24. The apparatus of claim 23, further comprising a module for monitoring said transactional, activity, behavioral, log and source information associated with said user related values for possible fraud.

25. The apparatus of claim 24, further comprising a fraud flagging module for flagging any possible fraud as determined during said step of monitoring said transactional, activity, behavioral, log and source information associated with said identity indicia for possible fraud, for disposition in accordance with predetermined rules.

26. The apparatus of claim 25, further comprising a module for generating a visual representation for display through a user terminal upon said communicating of said at least one portion of said user-friendly representation.

27. The apparatus of claim 26, wherein the module for generating said visual representation chosen from the group of visual depictions further comprises a module for generating a color or pattern associates with at least one of said visual depictions.

28. The apparatus of claim 27, wherein the module for receiving said identity indicia from said user further comprises a module for associating transactional and source information associated with said identity indicia.

29. The apparatus of claim 28, further comprising a module for monitoring said transactional and source information associated with said identity indicia for the existence of possible fraud is configured so as to be able to collect user related values before users have actively submitted input to a given site.

30. A method for representing a mathematical value in a user friendly way for use in confirming authentication, and identifying a sender of a message, comprising the steps of:
transmitting at least one user related value associated with a user for a computer entity;
receiving a mathematical value that has been generated by an online transaction entity based on said user related values;
receiving at least a portion of a user friendly representation of said mathematical value as generated by said online transaction entity;
determining an on line identity of said online entity based on said receiving of said at least one portion of said user friendly representation upon said generating of same, wherein the step of transmitting identity indicia from a user to said online transaction entity was performed in advance of the need to identify the system.

31. The method of claim 30, further comprising the step of transmitting a cue to the user via an electronic message.

32. The method of claim 31, wherein the step of receiving said visual representation for display on said user's terminal upon said communicating of said at least one portion of said user friendly representation further comprises the step of receiving said visual representation chosen from the group of visual depictions comprising geometric shapes, letters, numbers, freeform shapes, and pictures.

33. The method of claim 32, wherein the step of receiving said visual representation chosen from the group of graphical depictions further comprises the step of receiving a color or pattern associated with at least one of said visual depictions.

34. The method of claim 33, wherein the step of transmitting said identity indicia from the user further comprises transmitting transactional and source information associated with said user related values.

35. The method of claim 34 executed with a both front end and back-end protection.

36. The means for performing security techniques to prevent fraud using both front end and back-end protection

37. The computer-readable media of claim 14 further comprising the step of combining both front end and back-end protection.

38. The method of claim 1 further comprising the step of receiving a SSL certificate with said user related value and generating said mathematical value from said SSL certificate.

40. The method of claim 1, further comprising a false response step for responding to invalid input in such a way as to mimic the response to correct input so that it cannot be determined if a particular input is valid for a particular application.

41. The method of claim 18, further comprising a false response means for responding to invalid input in such a way as to mimic the response to correct input so that it cannot be determined if a particular input is valid for a particular application.
